(19) United States
(12) Patent Application Publication
(10) Pub. No.: US 2021/0355007 A1
(43) Pub. Date: Nov. 18, 2021

(54) SYSTEM AND METHOD FOR PREDICTING A PARAMETER ASSOCIATED WITH A WASTEWATER TREATMENT PROCESS

(71) Applicants: SEMBCORP INDUSTRIES LTD., Singapore (SG); National University of Singapore, Singapore (SG)

(72) Inventors: Ching Kwek POOI, Singapore (SG); How Yong NG, Singapore (SG); Xueqing SHI, Singapore (SG); Adrian Piah Song YEO, Singapore (SG); Wangdong NI, Singapore (SG)

(73) Assignees: SEMBCORP INDUSTRIES LTD., Singapore (SG); National University of Singapore, Singapore (SG)

(21) Appl. No.: 16/608,152

(22) PCT Filed: Dec. 13, 2018
(86) PCT No.: PCT/SG2018/050611

§ 371 Date: Oct. 24, 2019

(51) Int. Cl. C02F 3/00; G06N 20/00; G06N 5/04

(52) U.S. Cl. CPC C02F 3/006; G06N 20/00; G06N 5/04; C02F 2209/001; C02F 2209/20; C02F 2209/10; C02F 2209/08

(57) ABSTRACT

A system for predicting an effluent parameter associated with a wastewater treatment process including a predictor module configured to receive a first input dataset comprising a plurality of wastewater inflow parameters to predict a biodegradable type of effluent wastewater; a mechanistic simulator configured to receive the biodegradable type of effluent wastewater and the plurality of wastewater inflow parameters as a second input dataset to predict the effluent parameter.

### FIELD OF INVENTION

The present invention relates to a system and method for predicting one or more parameters associated with a wastewater treatment process.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Biological wastewater treatment processes are widely used and typically include anaerobic wastewater treatment and aerobic wastewater treatment.

In an aerobic wastewater treatment process, microorganisms such as bacteria, protozoa and fungi use dissolved oxygen as a key component to carry out biodegradation, such as carbonaceous Biological Oxygen Demand (BOD) degradation and removal of ammonia waste via nitrification. This may be regarded as ‘reducing the strength’ of the wastewater.

When the process is well operated, aerobic wastewater treatment processes are robust and reliable in treating wastewater to the required quality for effluent discharge.

Examples of aerobic wastewater processes commonly applied for industrial wastewater treatment include activated sludge processes, membrane bioreactors (suspended growth systems) or trickling filter and carrier-based treatment system such as the Moving Bed Biofilm Reactor (attached growth systems). In each of the above processes, oxygen is supplied to the microorganisms in an aeration tank, the tank which may include rotating equipment such as air blowers and compressors. The dissolved oxygen in the wastewater is utilized by the microorganisms as electron acceptors for aerobic decomposition of the carbonaceous BOD. At the end of the aerobic wastewater treatment process, BOD and other contaminants in the wastewater are oxidized to carbon dioxide and additional biomass.

It is appreciable that any non-biodegradable organics and unconsumed biodegradable organics may be discharged from the aerobic biological process and may be subjected to further treatment downstream, which can be an anaerobic or another aerobic treatment process. Any biomass (total weight of non-biodegradable organics and unconsumed biodegradable organics) will be collected in a settling tank such as a clarifier tank and recirculated back into an aeration tank to treat inflow wastewater.

Wastewater treatment process and apparatus may be deployed in a domestic and/or an industrial context. In an industrial context, wastewater treatment can be significantly more challenging as compared to its domestic wastewater counterpart. Different industries generate different types of wastewater, with different characteristics. Wastewater from different industries may differ in characteristics such as BOD, COD, pH and temperature, as a few examples. Coupled with uncertainties in operating hours and processes in the industrial plants, wastewater treatment process have to meet discharge standards. This pose an especially challenging tasks for centralized industrial wastewater biological treatment plants, where its feed streams (input) may contain wastewater from different industries with different characteristics.

To alleviate the difficulty associated with a centralized industrial wastewater biological treatment plants, simulations are often done to optimize a wastewater treatment plant performance, as well as to predict the performance of the treatment process. Such simulations are typically based on conventional mechanistic models. However, in such conventional mechanistic models, a user will typically have to set up a lab scale system, uses historical plant data or to perform respirometry analysis (amongst others) to determine the biodegradability of the inflow wastewater. These processes are typically labor intensive and time consuming.

Another approach used in the prediction of an outflow or effluent parameter from the aerobic biological process is the use of machine learning. Machine learning algorithms are able to recognize the pattern between the various inflow parameter data and outflow parameter data. The machine learning algorithm will then form a regression model between the outflow's parameter data and inflow's parameter data. Typically such machine learning and regression models can achieve a reasonable level of accuracy with average relative deviation of less than 10%. However, in scenarios where there is a sudden change in inflow parameter, such as the addition of new inflow stream, the model will not be able to accurately predict the outflow parameter because such model require training (learning) and the model is highly dependent on historical data.

It is an object to provide an improved system and method for prediction of parameters associated with wastewater treatment processes.

### SUMMARY

The applicant aim to address the aforementioned drawbacks by providing a hybrid model for the prediction of wastewater treatment process. The hybrid model is suitable for, but not limited to, an aerobic wastewater treatment process and can be used to predict one or more effluent parameters of an aerobic wastewater treatment process.

The effluent or outflow parameter may include, but is not limited to, a chemical oxygen demand (COD) measurement, nitrogenous content, mixed liquor volatile suspended solids of effluent water after aerobic treatment.

The hybrid model includes a predictor module and a mechanistic module arranged sequentially to predict the final outflow or effluent parameter. The prediction may comprise a two-step classification or prediction which includes classification of inflow parameters according to one or more biodegradability groups, and subsequently the prediction of an effluent wastewater parameter using the classified biodegradability groups and inflow parameters as input fed into the mechanistic module.

In some embodiments, the predictor module includes a machine learning model, which may be a regression-based model. Through the use of machine learning regression model, the model can predict the biodegradability group of the wastewater for the user. Once deployed, the machine learning regression based model correlates the biodegradability data to the inflow parameter data.

In some embodiments, the machine learning model can be trained, tested and validated using historical respirometry analysis of inflow wastewater. Such an arrangement is advantageous as users across the world can provide inflow parameter data for prediction of the biodegradability data. In addition, users can also provide biodegradability data and inflow parameter data, which will provide information for the database for the machine learning to be trained. This allows for faster data collection.

As different types of industries will generate wastewater of different characteristics, for example, wastewater from the pharmaceutical industries will have significant higher UV 254 parameter, also referred to as Spectral Absorption Coefficient (SAC) than that of the food industries, there is a need for different databases for different industries for the accurate prediction of biodegradability. The biodegradability data, as well as the wastewater inflow parameter data, will then be fed into the mechanistic model for biochemical process simulation.

By applying the hybrid model, design and optimization of wastewater treatment plant can be facilitated. A user can use the hybrid model to determine the biodegradability of the wastewater, which is crucial for wastewater treatment plant design. The model can also predict the wastewater outflow's quality, allowing a user to determine whether it is sufficient to meet any wastewater discharge standard. In addition, a user can also edit the treatment reactor size to optimize the treatment performance, potentially reducing the operation cost of the treatment plant.

According to an aspect there is a system for predicting an effluent parameter associated with a wastewater treatment process including a predictor module configured to receive a first input dataset comprising a plurality of wastewater inflow parameters and predict a biodegradable type of effluent wastewater; a mechanistic simulator configured to receive the biodegradable type of effluent wastewater and the plurality of wastewater inflow parameters as a second input dataset to produce the effluent parameter as a simulated output.

In some embodiments, the system includes a characterization module configured to correlate the plurality of wastewater inflow parameters with at least one biodegradable type, the characterization module arranged in data communication with the predictor module.

In some embodiments, the predictor module is arranged to receive the plurality of wastewater inflow parameters from at least one physical sensor and at least one soft sensor.

In some embodiments, the predictor module includes a machine learning module configured to learn the correlation between the plurality of wastewater inflow parameters with at least one biodegradable type.

In some embodiments, the biodegradable type is one of the following types: —(i.) biodegradable soluble, (ii.) non-biodegradable soluble, (iii.) slowly biodegradable colloidal, (iv.) slowly biodegradable particulates and (v.) non-biodegradable particulates.

In some embodiments, the plurality of wastewater inflow parameters include at least two of the following: —input chemical oxygen demand (COD), total organic carbon (TOC), solids content, ionic content, inorganic contaminant, organic contaminant.

In some embodiments, the mechanistic simulator includes an activated sludge model (ASM).

According to another aspect there is a method of predicting an effluent parameter associated with a wastewater process including the steps of: —(a.) receiving at a predictor module a first input dataset comprising a plurality of wastewater inflow parameters; (b.) predicting a biodegradable group associated with the effluent wastewater; (c.) combining the first input dataset and the biodegradable type of effluent wastewater to form a second input dataset; and (d.) receiving at a mechanistic simulator the second input dataset to provide a simulated effluent parameter.

In some embodiments, the method further includes the step of receiving at the mechanistic simulator sludge characteristics of the wastewater treatment process as part of the second input dataset.

In some embodiments, the method includes the step of correlating the plurality of wastewater inflow parameters with at least one biodegradable group.

In some embodiments, the first input dataset is obtained from at least one physical sensor and at least one soft sensor.

In some embodiments, the predictor module includes a machine learning module configured to learn the correlation between the plurality of wastewater inflow parameters with at least one biodegradable group.

In some embodiments, the biodegradable group is one of the following groups: —(i.) a biodegradable soluble group, (ii.) a non-biodegradable soluble group, (iii.) a slowly biodegradable colloidal group, (iv.) a slowly biodegradable particulates group and (v.) a non-biodegradable particulates group.

In some embodiments, the plurality of wastewater inflow parameters include at least two of the following: —input chemical oxygen demand (COD), total organic carbon (TOC), solids content, ionic content, inorganic contaminant, organic contaminant.

According to another aspect there is a non-transitory computer readable medium containing executable software instructions thereon wherein when executed performs the method of predicting an effluent parameter associated with a wastewater process including the steps of: —receiving a first input dataset comprising a plurality of wastewater inflow parameters; predicting a biodegradable group associated with the effluent wastewater; combining the first input dataset and the biodegradable type of effluent wastewater to form a second input dataset; and receiving at a mechanistic simulator the second input dataset to provide a simulated effluent parameter.

Other aspects and features will become apparent to those of ordinary skill in the art upon review of the following description of specific embodiments in conjunction with the accompanying figures.

### BRIEF DESCRIPTION OF THE DRAWINGS

In the figures, which illustrate, by way of example only, embodiments of the present disclosure,

FIG. 1: is a system diagram of a system for predicting a parameter associated with wastewater treatment according to some embodiments of the invention.

FIG. 2: is a flow chart illustrating a method of predicting a parameter associated with wastewater treatment according to some embodiments of the invention.

FIG. 3: illustrates possible inputs and outputs associated with a machine learning module. As an example, the machine learning will then predict the outputs associated with different groups of biodegradability of the wastewater.

FIG. 4a and FIG. 4b: show the result where the system is utilized for prediction of effluent chemical oxygen demand (COD) of two wastewater treatment processes.

### DETAILED DESCRIPTION

Throughout this document, unless otherwise indicated to the contrary, the terms “comprising”, “consisting of”, “having” and the like, are to be construed as non-exhaustive, or in other words, as meaning “including, but not limited to”.

Furthermore, throughout the specification, unless the context requires otherwise, the word “include” or variations such as “includes” or “including” will be understood to imply the inclusion of a stated integer or group of integers but not the exclusion of any other integer or group of integers.

Unless defined otherwise, all technical and scientific terms used herein have the same meaning as is commonly understood by a skilled person to which the subject matter herein belongs.

In accordance with an aspect there is a system for predicting one or more parameters associated with a wastewater treatment process including a predictor module and a mechanistic simulator, the predictor module operable to receive a plurality of wastewater inflow parameters as a first input dataset to predict a biodegradable type of effluent wastewater; and the mechanistic simulator operable to receive the biodegradable type of effluent wastewater and the plurality of wastewater inflow parameters as a second input dataset to predict an effluent parameter.

Depending on industry, the second input dataset may also include additional data such as a sludge characterization data.

It is appreciable that the plurality of wastewater inflow parameters or dataset can include two or more of the following list of dataset obtained over to specified time horizon: —chemical oxygen demand (COD), total organic carbon (TOC), solids content, ionic content, inorganic contaminant, organic contaminant. Sensors (both physical and soft sensors) may be positioned around one or more wastewater treatment plants to facilitate the data collection process.

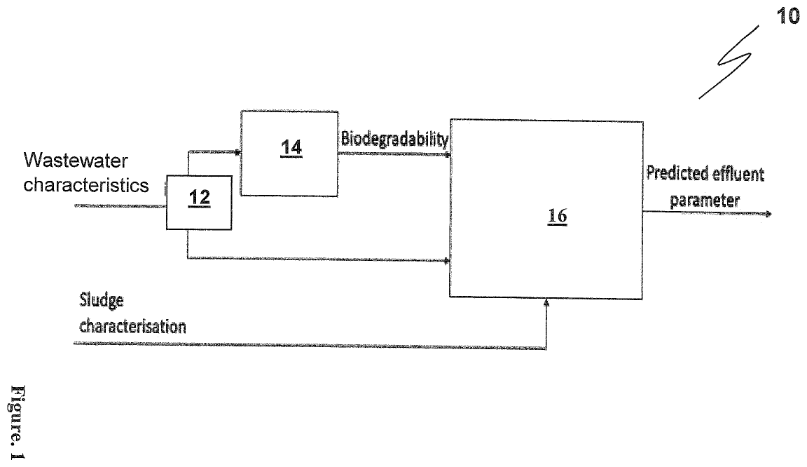

FIG. 1 shows a system 10 for predicting one or more parameters associated with a wastewater treatment process. The system 10 includes a characterization module 12, a predictor module 14, and a mechanistic simulator 16. Each of the modules 12, 14 and 16 may include one or more computer processors, one or more centralized or distributed computer networks, such computer networks may include a cloud network. The computer networks may be arranged in data communication with industry-specific wastewater treatment plants to receive the required dataset, via physical or software (soft) sensors deployed at desired locations on the wastewater treatment plants.

The characterization module 12 may include hardware components such as server computer(s) arranged in a distributed or non-distributed configuration to implement characterization databases. The hardware components may be supplemented by a database management system configured to compile one or more industry-specific characteristic databases. In some embodiments, such industry-specific characteristic databases may include one or more correlation table between biodegradability data of effluent wastewater obtained from at least one specific industry and its corresponding inflow wastewater data or parameters. In some embodiments, the industry-specific characteristic databases may include analysis modules to correlate one or more dataset with an industry. Such analysis modules may include an expert rule database, a fuzzy logic system, or any other artificial intelligence module.

In some embodiments, the at least one specific industry includes one of the following: —petrochemical industry, pharmaceutical industry, pulp and paper industry, sewage treatment industry etc.

It is appreciable that for different industries, different characteristic databases are required, as the characteristic and constituents of the wastewater can differ greatly between different industries. Hence, a database for petrochemical industry may not be applicable or suitable to the pharmaceutical industry. Inflow parameters such as chemical oxygen demand (COD), carbon content, nitrogenous content, dissolved solids, ion concentrations, and chemical composition can be included into the database.

Over time, it is appreciable that different characteristic databases corresponding to different industries are generated and populated. These data are grouped according to the type of industry for subsequent learning and operation of the predictor module 14. The characterization module 12 can also be updated as and when new data is received by the system 10.

In some embodiments, the biodegradability group/classification of different samples of wastewater can be based on biodegradability data obtained from a bioassay method (e.g. respirometry), a simple jar test (lab scale test) or historical data of the specific wastewater treatment plant. In some embodiments, multiple classification methods may be used and the average results, or weighted average results across different classification methods obtained.

Once the characteristic databases are generated, a selected dataset relevant to an industry (also referred to as a first input dataset), can be fed into the predictor module 14. The predictor module 14 is configured to learn based on the first input dataset. The predictor module 14 may include one or more machine learning algorithms, such as an artificial neural network and/or decision tree regression to learn or correlate the biodegradability data to its corresponding inflow parameter data. The machine learning algorithm then generates an output according to the inflow parameter data. The output can be the biodegradability data corresponding to the inflow parameter data. In some embodiments, the biodegradability data may be grouped as follows: —(i.) biodegradable soluble, (ii.) non-biodegradable soluble, (iii.) slowly biodegradable colloidal, (iv.) slowly biodegradable particulates and (v.) non-biodegradable particulates.

In some embodiments, further sub-groups from the above five groups may be formed. For example, in the case where the inflow parameter is a total organic carbon (tCOD) parameter of the wastewater, the biodegradable soluble group can be further sub-divided into readily biodegradable and soluble inert in addition to slowly biodegradable colloidal.

The non-biodegradable particulates group may include particulate inert, which is an insoluble portion of COD unaffected by biological activity and is thus retained in the system without being biodegraded. The particulate inert parameter affects mixed liquor parameter and can be estimated by comparison with real plant data, which can be based on simulation studies to real plant data and/or trial and error studies.

In the case of a non-biodegradable soluble COD, it may be referred to as inert soluble COD. The inert soluble COD is a soluble portion of COD which is unaffected by biological activity. The inert soluble COD parameter affects effluent COD concentration/sludge growth, and may be determined by direct plant/lab scale reactor measurement. The inert soluble COD may be equivalent or correlated to a filtered effluent COD. The inert soluble COD parameter may be obtained via historical data.

Slowly biodegradable COD (sbCOD) may refer to colloidal and particulate materials, which may correspond to extracellular enzymatic breakdown prior to adsorption and consumption. In some embodiments, the sbCOD parameter may be expressed mathematically in equation (1) as follows: —

sbCOD=CODₜₒₜₐₗ−COD_{readily biodegradable}−COD_{soluble inert}−COD_{particulate inert} (1)

In relation to readily biodegradable COD (rbCOD), the rbCOD group refers to small soluble molecules that can be readily adsorbed and consumed by microbes. The rbCOD parameter can be derived or obtained from a bioassay method mathematically expressed as equation (2).

$$rbCOD = \frac{\int {r}_{o 2} - \int {r}_{O 2 , Baseline respiration}}{1 - {Y}_{H}} \\ {Y}_{H} = 1 - \frac{CO}{{COD}_{sodium acetate}} \qquad ( 2 )$$

Wherein the various parameters include rₒ₂ refers to respiration rate, CO refers to consumed oxygen.

In general, organics in wastewater can be differentiated into biodegradability and solubility. These organics affects the overall performance of the wastewater treatment.

It is appreciable that in some embodiments, the machine learning module may be based on either a supervised learning or unsupervised learning.

Different machine learning model may be used, depending on the suitability of such machine learning model with the different industries. For example, neural networks typically used for machine learning may be combined with other algorithms for tuning of the applicable weights of each neuron in the neural network.

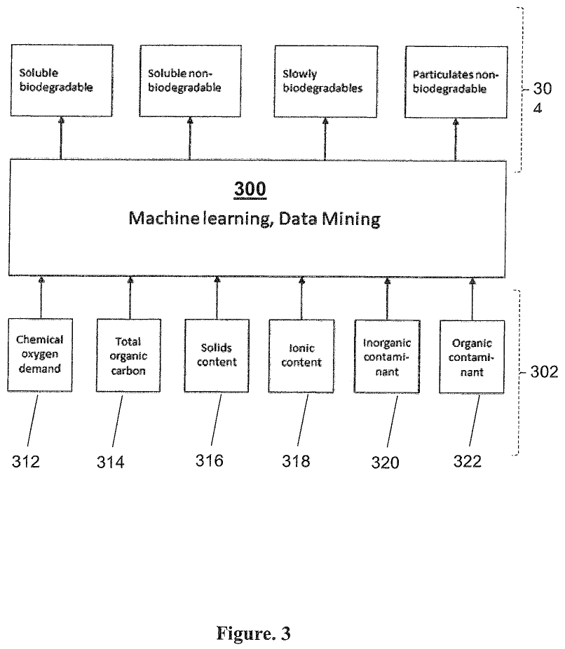

Once the machine learning model is trained and validated, a new inflow wastewater (typically not a data entry within the classification database) may be utilized to predict its biodegradability group according to FIG. 3. The predicted biodegradability group, together with the wastewater inflow parameter(s) and sludge characterization data, if any, is combined as a second input dataset and fed into the mechanistic simulator 16. The mechanistic simulator 16 is used to mimic a biochemical processes in wastewater treatment to predict an outflow or effluent parameter.

In some embodiments, the mechanistic simulator 16 may be an Activated Sludge Model (ASM).

The mechanistic simulator 16 is operate to simulate the outflow parameter so as to predict and/or determine a final output effluent wastewater parameter. Effluent wastewater parameters such as chemical oxygen demand COD, nitrogenous content, mixed liquor volatile suspended solids can be predicted as the final output effluent wastewater parameter. The overall process of the model is illustrated in FIG. 1.

According to another aspect of the invention/disclosure there is a method for predicting an effluent parameter associated with a wastewater process including the steps of: —(a.) receiving at a predictor module a first input dataset comprising a plurality of wastewater inflow parameters; (b.) predicting a biodegradable group associated with the effluent wastewater; (c.) combining the first input dataset and the biodegradable type of effluent wastewater to form a second input dataset; and (d.) receiving at a mechanistic simulator the second input dataset to provide a simulated effluent parameter.

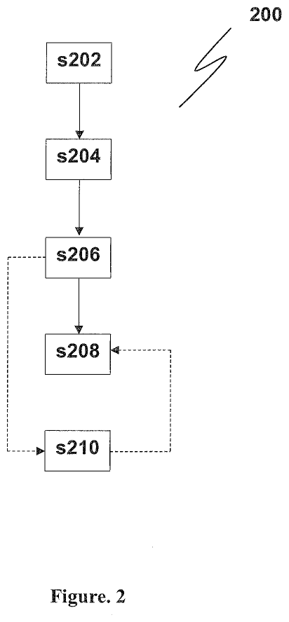

FIG. 2 is a flow chart illustrating a method of predicting a parameter associated with a wastewater process 200. The method 200 suitably works with the system 10 and may be used an effluent wastewater treatment parameter such as the COD of an aerobic wastewater treatment plant. The method 200 includes the steps of: —receiving at a predictor module a first input dataset comprising a plurality of wastewater inflow parameters (step s202); predicting a biodegradable type of effluent wastewater (step s204); combining the first input dataset and the predicted biodegradable type of effluent wastewater to form a second input dataset (step s206); and receiving at a mechanistic simulator 16 the second input dataset to predict a resultant effluent parameter (step s208).

An example of the first input dataset and biodegradable type of effluent wastewater may be illustrated as shown in Table 1. Table 1 shows the input parameters in the form of COD, soluble COD (sCOD), Dissolved Organic Carbon (DOC), Total nitrogen (TN), Bromine (Br), Total Dissolved Solids (TDS), and the predicted inert sCOD fraction which is output from the predictor module 14.

TABLE 1
Example inputs and output parameter (sCOD) obtained from the predictor module 14.

| | | | | | | | Predicted Inert |
|---|---|---|---|---|---|---|---|
| Days | COD | SCOD | DOC | TN | Br | TDS | sCOD fraction |
| 0 | 111.3121 | 79.525 | 80.465 | 19.61 | 0 | 2910 | 0.485859217 |
| 10 | 361.25 | 293.5533 | 104.7 | 13.31266 | 941.574 | 8720 | 0.362281253 |
| 22 | 428.7667 | 372.3667 | 90.08667 | 16.024 | 1607.567 | 5965 | 0.348598022 |
| 35 | 291.6 | 274.77 | 66.37 | 12.059 | 471.096 | 3920 | 0.423322733 |
| 43 | 249.54 | 178.6913 | 35.06 | 33.7 | 64.264 | 3633.33 | 0.245924686 |
| 55 | 499.77 | 472.31 | 67.94 | 25.52 | 1221.8 | 5675 | 0.272245125 |
| 68 | 232.225 | 155.895 | 39.73 | 28.3 | 66.525 | 2880 | 0.246497874 |
| 77 | 593.217 | 479.2473 | 83.4625 | 10.17125 | 1159.793 | 2000 | 0.259749755 |
| 92 | 447.51 | 393.06 | 58.47 | 12.1305 | 1386.227 | 2830 | 0.331460455 |
| 101 | 125.22 | 95.08 | 25.7 | 23.29 | 40 | 1600 | 0.413202803 |
| 115 | 533.58 | 467.33 | 63.12 | 27.685 | 1007.663 | 5045 | 0.23644336 |
| 126 | 69.03 | 58.7 | 15.44 | 30.69 | 12.78825 | 4126.7 | 0.21303065 |
| 136 | 79.37 | 78.34 | 24.84 | 29.96 | 5 | 2779.167 | 0.375865261 |
| 149 | 359.29 | 310.58 | 38.3 | 25.76 | 1338.575 | 4705 | 0.246553386 |
| 162 | 509.02 | 428.665 | 55.91 | 48.1533 | 1227.612 | 3253 | 0.21167823 |
| 168 | 418.82 | 337.97 | 36.1 | 38.29 | 1245.62 | 3540 | 0.202502789 |

In some embodiments, the method 200 also include the step of receiving sludge characterization data as part of the second input dataset (step s210) after step s206. The sludge characterization data may then be fed into the mechanistic simulator (step s208).

In some embodiments, the first input dataset may be obtained from physical and/or soft sensors displaced in or on suitable locations of an aerobic wastewater treatment plant. The aerobic wastewater treatment plant may be arranged upstream of subsequent wastewater treatment processes such as anaerobic wastewater treatment (not shown).

In some embodiments, the method 200 can be installed as executable software codes in a non-transitory computer readable medium. Such computer readable medium may be in the form of memory units, such as random access memory (RAM), read only memory (ROM), hard disks, application specific integrated circuit chip (ASIC), and/or field-programmable gate array (FPGA). In some embodiments, the non-transitory computer readable medium can be integrated with the physical and/or soft sensors for detecting inflow and outflow parameters.

FIG. 3 shows an example of the predictor module 14 in the form of a machine learning or artificial intelligence module 300. The machine learning module 300 is configured to receive an input set 302 to generate an output or output set 304.

The input set 302 may include a list of wastewater inflow data such as chemical oxygen demand 312, total organic carbon 314, solids content 316, ionic content 318, inorganic contaminant 320, and organic contaminant 322. The output 304 generated may be in the form of the following biodegradable classifications or groups, including, but not limited to, a soluble biodegradable group, a soluble non-biodegradable group, a slowly biodegradables group, and a particulates non-biodegradable group.

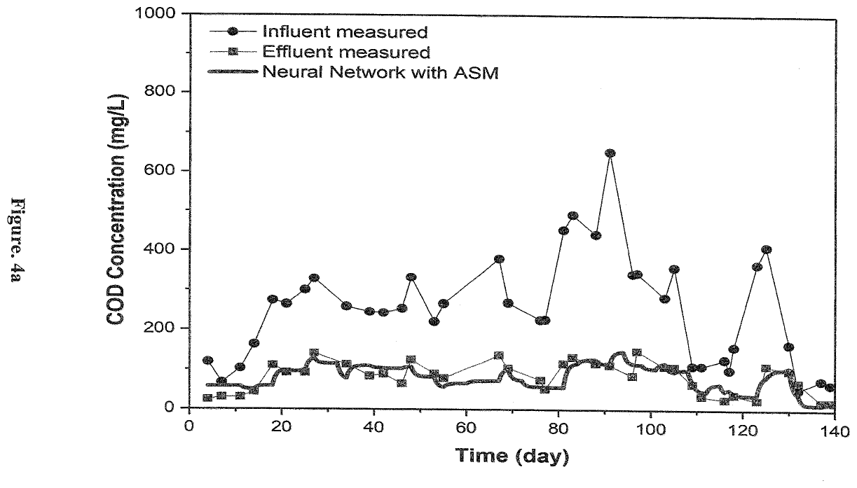

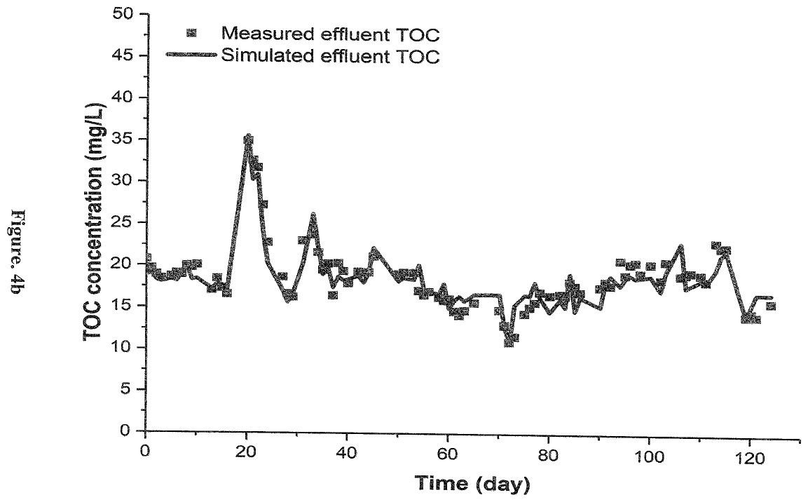

FIG. 4a is a result showing the application of the system 10 and method 200 to the prediction of an output effluent COD (in milligrams per litre mg/L) of the effluent wastewater in an aerobic wastewater treatment process. The graph in FIG. 4a plots the COD concentration of influent wastewater and treated effluent wastewater. The predictor algorithm based on a neural work was utilized. The results were compared with the actual measured effluent discharge and demonstrated reasonable accuracy. The inflow COD level is also plotted to demonstrate the efficacy and effectiveness of the aerobic wastewater treatment process in reducing the amount of COD level after wastewater treatment.

FIG. 4b is a result showing the application of the system 10 and method 200 to the prediction of an output effluent COD (in mg/L) of the effluent wastewater in another aerobic wastewater treatment process. The comparison shows a good tracking of the simulated effluent COD with respect to the actual measured effluent COD having an average relative deviation of less than 7% and normalised root mean square error of less than 0.1.

The use of machine learning to correlate the inflow parameter to biodegradability of inflow wastewater is advantageous in that it results in significant savings in labour and time required to determine a biodegradability of inflow wastewater. In addition, as the system 10 takes into account various industries via the characterization module, new wastewater stream can be easily incorporated and biodegradability correlated by training of the neural network. In addition, the system 10 is capable of predicting one or more outflow parameter regardless of flowrate of inflow wastewater streams. This is contrasted to existing systems where new wastewater stream are required to undergo treatability study to determine the associated industry. With the characterization module 12, any new wastewater stream may be quickly characterized or classified into an industry source.

In some embodiments, the obtainment of the first input dataset, second input dataset may be achieved remotely or separately from the computer systems utilized for processing them.

In some embodiments, two or more of the characterization module 12, the predictor module 14, and the mechanistic simulator 16 may be integrated in a single processor, computer, or server. In these embodiments, which may form another aspect, there may include a non-transitory computer readable medium containing executable software instructions thereon wherein when executed performs a method of predicting an effluent parameter associated with a wastewater process including the steps of: —receiving a first input dataset comprising a plurality of wastewater inflow parameters; predicting a biodegradable group associated with the effluent wastewater; combining the first input dataset and the biodegradable type of effluent wastewater to form a second input dataset; and receiving at a mechanistic simulator the second input dataset to provide a simulated effluent parameter.

It should be appreciated by the person skilled in the art that the above invention is not limited to the embodiment described. In particular, various embodiments may be applied to anaerobic wastewater treatment. It is appreciable that modifications and improvements may be made without departing from the scope of the present invention.

It should be further appreciated by the person skilled in the art that one or more of the above modifications or improvements, not being mutually exclusive, may be further combined to form yet further embodiments of the present invention.

1. A system for predicting an effluent parameter associated with a wastewater treatment process including
a predictor module configured to receive a first input dataset comprising a plurality of wastewater inflow parameters and predict a biodegradable group, the predictor module further configured to correlate the biodegradable group to the corresponding inflow parameters;
a mechanistic simulator configured to receive the biodegradable group and the plurality of wastewater inflow parameters as a second input dataset to produce the effluent parameter as a simulated output.

2. The system of claim 1, further including a characterization module configured to correlate the plurality of wastewater inflow parameters with at least one industry type, the characterization module arranged in data communication with the predictor module.

3. The system of claim 2, wherein the characterization module includes a plurality of characterization databases, the plurality of characterization databases include at least one correlation table between the at least one biodegradable group and the corresponding inflow wastewater parameters, obtained from at least one specific industry.

4. The system of claim 1, wherein the predictor module is arranged to receive the plurality of wastewater inflow parameters from at least one physical sensor and at least one soft sensor.

5. The system of claim 1, wherein the predictor module includes a machine learning module configured to learn the correlation between the plurality of wastewater inflow parameters with at least one biodegradable type.

6. The system of claim 1, wherein the biodegradable group is one of the following groups: —(i.) biodegradable soluble, (ii.) non-biodegradable soluble, (iii.) slowly biodegradable colloidal, (iv.) slowly biodegradable particulates and (v.) non-biodegradable particulates.

7. The system of claim 1, wherein the plurality of wastewater inflow parameters include at least two of the following: —input chemical oxygen demand (COD), total organic carbon (TOC), solids content, ionic content, inorganic contaminant, organic contaminant.

8. The system of claim 1, wherein the mechanistic simulator includes an activated sludge model (ASM).

9. A method of predicting an effluent parameter associated with a wastewater process including the steps of: —
(a.) receiving at a predictor module a first input dataset comprising a plurality of wastewater inflow parameters;
(b.) correlating the plurality of wastewater inflow parameters with a biodegradable group;
(c.) predicting the biodegradable group based on the correlation with the wastewater inflow parameters;
(d.) combining the first input dataset and the biodegradable group of to form a second input dataset; and
(e.) receiving at a mechanistic simulator the second input dataset to provide a simulated effluent parameter.

10. The method of claim 9, further including the step of receiving at the mechanistic simulator sludge characteristics of the wastewater treatment process as part of the second input dataset.

11. The method of claim 9, further including the step of correlating the plurality of wastewater inflow parameters with at least one industry type.

12. The method of claim 9, wherein the first input dataset is obtained from at least one physical sensor and at least one soft sensor.

13. The method of claim 9, wherein the predictor module includes a machine learning module configured to learn the correlation between the plurality of wastewater inflow parameters with at least one biodegradable group.

14. The method of claim 9, wherein the biodegradable group is one of the following groups: —(i.) a biodegradable soluble group, (ii.) a non-biodegradable soluble group, (iii.) a slowly biodegradable colloidal group, (iv.) a slowly biodegradable particulates group and (v.) a non-biodegradable particulates group.

15. The method of claim 9, wherein the plurality of wastewater inflow parameters include at least two of the following: —input chemical oxygen demand (COD), total organic carbon (TOC), solids content, ionic content, inorganic contaminant, organic contaminant.

16. A non-transitory computer readable medium containing executable software instructions thereon wherein when executed performs the method of predicting an effluent parameter associated with a wastewater process including the steps of: —receiving a first input dataset comprising a plurality of wastewater inflow parameters; correlating the plurality of wastewater inflow parameters with a biodegradable group; predicting the biodegradable group associated with the wastewater inflow parameters; combining the first input dataset and the biodegradable group to form a second input dataset; and receiving at a mechanistic simulator the second input dataset to provide a simulated effluent parameter.
